(19) United States
(12) Patent Application Publication
(10) Pub. No.: US 2026/0289386 A1
(43) Pub. Date: Sep. 24, 2026

(54) FEDERATED MACHINE LEARNING-BASED ANOMALY DETECTION ACROSS MULTIPLE DATA CENTERS

(71) Applicant: Dell Products L.P., Round Rock, TX (US)

(72) Inventors: Zijia Wang, London (GB); Mustafa AlBado, Cork (IE); Srinath Kappgal, Cork (IE)

(21) Appl. No.: 19/083,787

(22) Filed: Mar. 19, 2025

(51) Int. Cl. G06N 20/00

(52) U.S. Cl. CPC G06N 20/00

(57) ABSTRACT

An apparatus comprises at least one processing device configured to generate graph structure representations of a first set of logs associated with information technology assets in a first data center, to train a first machine learning-based anomaly detection model utilizing the graph structure representations, to train a second machine learning-based anomaly detection model by distilling knowledge of the first machine learning-based anomaly detection model, and to update the second machine learning-based anomaly detection model based on an aggregation of parameters of the second machine learning-based anomaly detection model and additional parameters of additional machine learning-based anomaly detection models trained utilizing logs associated with information technology assets of additional data centers. The at least one processing device is also configured to perform anomaly detection on a second set of logs associated with the information technology assets in the first data center utilizing the updated second machine learning-based anomaly detection model.

### BACKGROUND

As the value and use of information continues to increase, individuals and businesses seek additional ways to process and store information. Information processing systems may be used to process, compile, store and communicate various types of information, including through the use of artificial intelligence (AI) and machine learning (ML). Anomaly detection models may utilize AI/ML algorithms to detect anomalous events occurring on information technology assets in an information technology infrastructure.

### SUMMARY

Illustrative embodiments of the present disclosure provide techniques for federated machine learning-based anomaly detection across multiple data centers.

In one embodiment, an apparatus comprises at least one processing device comprising a processor coupled to a memory. The at least one processing device is configured to generate graph structure representations of a first set of logs associated with information technology assets in a first data center, to train a first machine learning-based anomaly detection model utilizing the generated graph structure representations, to train a second machine learning-based anomaly detection model at least in part by distilling knowledge of the first machine learning-based anomaly detection model, and to update the second machine learning-based anomaly detection model based at least in part on an aggregation of (i) a set of one or more parameters of the second machine learning-based anomaly detection model and (ii) one or more additional sets of one or more parameters of one or more additional machine learning-based anomaly detection models trained utilizing one or more additional sets of logs associated with information technology assets of one or more additional data centers. The at least one processing device is also configured to perform anomaly detection on a second set of logs associated with the information technology assets in the first data center utilizing the updated second machine learning-based anomaly detection model.

These and other illustrative embodiments include, without limitation, methods, apparatus, networks, systems and processor-readable storage media.

### BRIEF DESCRIPTION OF THE DRAWINGS

FIG. 1 is a block diagram of an information processing system configured for federated machine learning-based anomaly detection across multiple data centers in an illustrative embodiment.

FIG. 2 is a flow diagram of an exemplary process for federated machine learning-based anomaly detection across multiple data centers in an illustrative embodiment.

FIG. 3 shows a federated hierarchical graph anomaly recognition framework configured for anomaly detection utilizing server logs distributed across multiple data centers in an illustrative embodiment.

FIG. 4 shows a process flow for implementing a mutual information framework aligning node embeddings with structural embeddings through local mutual information maximization while differentiating normal and anomalous structural embeddings via global mutual information minimization in an illustrative embodiment.

FIG. 5 shows a process flow for implementing a bilateral knowledge distillation mechanism for transferring knowledge from teacher models to student models within data centers, aggregating parameters at a central server, and redistributing a global student model in an illustrative embodiment.

FIG. 6 shows a process flow for implementing a federated parameter aggregation process consolidating student model parameters from distributed data centers producing a unified global student model in an illustrative embodiment.

FIG. 7 shows a table of evaluation metrics for performing anomaly detection utilizing a federated hierarchical graph anomaly recognition framework and multiple baseline methods in an illustrative embodiment.

FIG. 8 shows a table of evaluation metrics for performing anomaly detection utilizing a full federated hierarchical graph anomaly recognition framework and implementations of the federated hierarchical graph anomaly recognition framework without temporal graph distillation and without bilateral knowledge distillation in an illustrative embodiment.

FIGS. 9 and 10 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

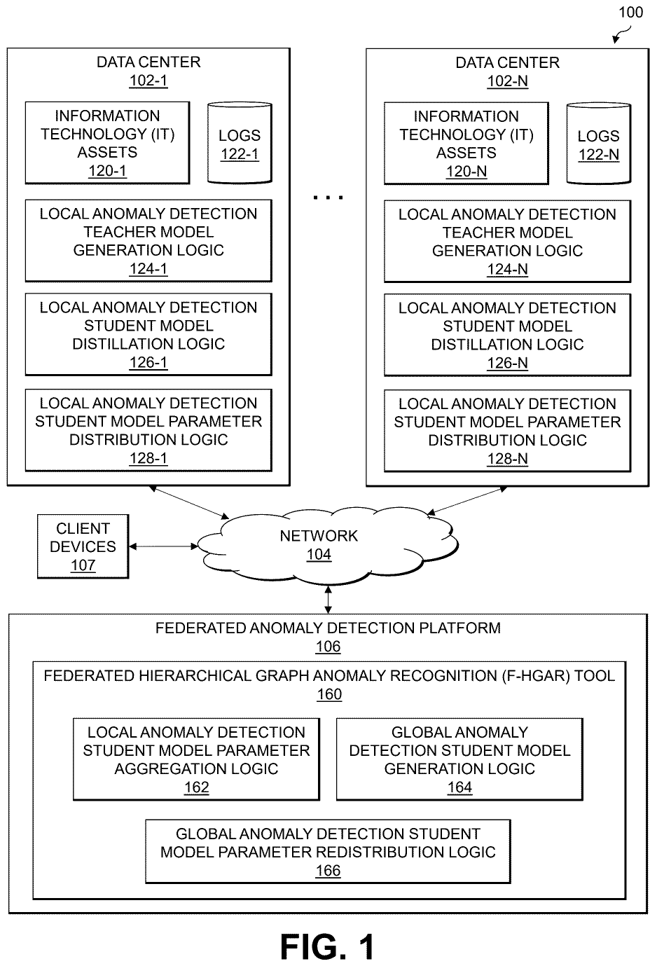

FIG. 1 shows an information processing system 100 configured in accordance with an illustrative embodiment. The information processing system 100 is assumed to be built on at least one processing platform and provides functionality for federated machine learning-based anomaly detection across multiple data centers. The information processing system 100 includes a set of data centers 102-1, . . . 102-N (collectively, data centers 102) which are coupled to a network 104. Also coupled to the network 104 is a federated anomaly detection platform 106. The data centers 102 comprise respective sets of information technology (IT) assets 120-1, . . . 120-N (collectively, IT assets 120) which provide logs 122-1, . . . 122-N (collectively, logs 122). The IT assets 120 may comprise physical and/or virtual computing resources in the data centers 102. Physical computing resources may include physical hardware such as servers, storage systems, networking equipment, Internet of Things (IoT) devices, other types of processing and computing devices including desktops, laptops, tablets, smartphones, etc. Virtual computing resources may include virtual machines (VMs), containers, etc. The data centers 102 perform anomaly detection utilizing their respective sets of logs 122 utilizing one or more federated anomaly detection models that operate on graph data derived from the logs 122. The federated anomaly detection platform 106 facilitates generation and distribution of the one or more federated anomaly detection models to the data centers 102 utilizing Federated Hierarchical Graph Anomaly Recognition (F-HGAR) tool 160.

In some embodiments, the federated anomaly detection platform 106 is used for an enterprise system. For example, an enterprise may subscribe to or otherwise utilize the federated anomaly detection platform 106 for performing federated graph-based anomaly detection with temporal distillation for server logs generated across multiple data centers 102 (e.g., geographically-distributed data centers) maintaining data privacy through training locally at each of the data centers 102 and exchanging only model parameters with the federated anomaly detection platform 106 (e.g., a central server or servers). As used herein, the term “enterprise system” is intended to be construed broadly to include any group of systems or other computing devices. For example, the IT assets 120 of the data centers 102 may provide a portion of one or more enterprise systems. A given enterprise system may also or alternatively include one or more client devices 107 coupled to the network 104 which access or utilize the IT assets 120 of the data centers 102 and/or the federated anomaly detection platform 106. In some embodiments, an enterprise system includes the data centers 102, cloud infrastructure comprising one or more clouds implementing the data centers 102, etc. A given enterprise system, such as cloud infrastructure, may host assets that are associated with multiple enterprises (e.g., two or more different businesses, organizations or other entities).

The client devices 107 may comprise, for example, physical computing devices such as IoT devices, mobile telephones, laptop computers, tablet computers, desktop computers or other types of devices utilized by members of an enterprise, in any combination. Such devices are examples of what are more generally referred to herein as “processing devices.” Some of these processing devices are also generally referred to herein as “computers.” The client devices 107 may also or alternately comprise virtualized computing resources, such as VMs, containers, etc.

The client devices 107 in some embodiments comprise respective computers associated with a particular company, organization or other enterprise. Thus, the client devices 107 may be considered examples of assets of an enterprise system. In addition, at least portions of the information processing system 100 may also be referred to herein as collectively comprising one or more “enterprises.” Numerous other operating scenarios involving a wide variety of different types and arrangements of processing nodes are possible, as will be appreciated by those skilled in the art.

The network 104 is assumed to comprise a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks.

The sets of logs 122 may be stored in one or more databases or other data stores, which may store raw logs, graph structures derived from logs, etc. Such databases or other data stores may also store local anomaly detection teacher and student models and parameters thereof, as well as global student model parameters distributed from the F-HGAR tool 160 of the federated anomaly detection platform 106 to the data centers 102. Such databases or other data stores may be implemented utilizing one or more storage systems. The term “storage system” as used herein is intended to be broadly construed. A given storage system, as the term is broadly used herein, can comprise, for example, content addressable storage, flash-based storage, network-attached storage (NAS), storage area networks (SANs), direct-attached storage (DAS) and distributed DAS, as well as combinations of these and other storage types, including software-defined storage. Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although not explicitly shown in FIG. 1, one or more input-output devices such as keyboards, displays or other types of input-output devices may be used to support one or more user interfaces to the data centers 102 and the federated anomaly detection platform 106, as well as to support communication between the data centers 102, the federated anomaly detection platform 106 and other related systems and devices not explicitly shown.

The federated anomaly detection platform 106 may be provided as a cloud service that is accessible by one or more of the client devices 107 to allow users thereof to manage generation and distribution of global anomaly detection student model parameters from the federated anomaly detection platform 106 to the data centers 102 (e.g., for updating and refining local anomaly detection student models maintained at each of the data centers 102). In some embodiments, the client devices 107 are assumed to be associated with users of an enterprise, organization or other entity that seeks to manage and perform anomaly detection across the data centers 102. In some embodiments, the client devices 107 are utilized by members of the same enterprise, organization or other entity that operates the federated anomaly detection platform 106. In other embodiments, the client devices 107 are utilized by members of one or more enterprises, organizations or other entities different than the enterprise, organization or other entity that operates the federated anomaly detection platform 106 (e.g., a first enterprise provides support functionality for multiple different customers, businesses, etc.). Various other examples are possible.

In some embodiments, the client devices 107 and/or the IT assets 120 of the data centers 102 may implement host agents that are configured for automated transmission of information with the federated anomaly detection platform 106 (e.g., local anomaly detection student model parameters, global anomaly detection student model parameters, etc.). It should be noted that a “host agent” as this term is generally used herein may comprise an automated entity, such as a software entity running on a processing device. Accordingly, a host agent need not be a human entity.

The data centers 102 and the federated anomaly detection platform 106 in the FIG. 1 embodiment is assumed to be implemented using at least one processing device. Each such processing device generally comprises at least one processor and an associated memory, and implements one or more functional modules or logic for controlling certain features of the data centers 102 and the federated anomaly detection platform 106. In the FIG. 1 embodiment, each of the data centers 102 implements respective instances of local anomaly detection teacher model generation logic 124-1, . . . 124-N (collectively, local anomaly detection teacher model generation logic 124), local anomaly detection student model distillation logic 126-1, . . . 126-N (collectively, local anomaly detection student model distillation logic 126) and local anomaly detection student model parameter distribution logic 128-1, . . . 128-N (collectively, local anomaly detection student model parameter distribution logic 128). The local anomaly detection teacher model generation logic 124 is configured to generate, for each of the data centers 102, a local anomaly detection teacher model (e.g., combining a Generative Adversarial Anomaly Module (GAAM) employing adversarial generation and local-global mutual information to distinguish normal from anomalous graphs and a Temporal Graph Distillation (TGD) sub-module integrated within the GAAM's teacher model which partitions the logs 122 into time-sliced subgraphs to capture transient or short-lived anomalies). The local anomaly detection student model distillation logic 126 is configured to generate, for each of the data centers, a local anomaly detection student model by transferring knowledge of its local anomaly detection teacher model (e.g., the combination of its GAAM and TGD sub-module) to a lightweight student model for efficient federated aggregation and global collaboration. If available, the local anomaly detection student model distillation logic 126 will also incorporate information relating to a global anomaly detection student model (e.g., parameters thereof) produced by the F-HGAR tool 160 of the federated anomaly detection platform 106 in distilling an iteration or update of the local anomaly detection student model. The local anomaly detection student model parameter distribution logic 128 is configured, for each of the data centers 102, to provide parameters of its local anomaly detection student model to the federated anomaly detection platform 106 for aggregation with parameters of the local anomaly detection student models of other ones of the data centers 102.

The federated anomaly detection platform 106 implements F-HGAR tool 160 comprising local anomaly detection student model parameter aggregation logic 162, global anomaly detection student model generation logic 164, and global anomaly detection student model parameter redistribution logic 166. The local anomaly detection student model parameter aggregation logic 162 is configured to collect model parameters from the local anomaly detection student models generated at each of the data centers 102. The global anomaly detection student model generation logic 164 is configured to generate, based on the aggregated local anomaly detection student model parameters, a global anomaly detection student model. The global anomaly detection student model parameter redistribution logic 166 is configured to distribute parameters of the generated global anomaly detection student model back to the data centers 102 (e.g., for use in iterating or updating their respective local anomaly detection student models).

At least portions of the local anomaly detection teacher model generation logic 124, the local anomaly detection student model distillation logic 126, the local anomaly detection student model parameter distribution logic 128, the F-HGAR tool 160, the local anomaly detection student model parameter aggregation logic 162, the global anomaly detection student model generation logic 164, and the global anomaly detection student model parameter redistribution logic 166 may be implemented at least in part in the form of software that is stored in memory and executed by a processor.

It is to be appreciated that the particular arrangement of the data centers 102, the federated anomaly detection platform 106 and the client devices 107 illustrated in the FIG. 1 embodiment is presented by way of example only, and alternative arrangements can be used in other embodiments. As discussed above, for example, the federated anomaly detection platform 106 (or portions of components thereof, such as one or more of the F-HGAR tool 160, the local anomaly detection student model parameter aggregation logic 162, the global anomaly detection student model generation logic 164, and the global anomaly detection student model parameter redistribution logic 166) may in some embodiments be implemented internal to one of the data centers 102.

The federated anomaly detection platform 106 and other portions of the information processing system 100, as will be described in further detail below, may be part of cloud infrastructure.

The federated anomaly detection platform 106 and other components of the information processing system 100 in the FIG. 1 embodiment are assumed to be implemented using at least one processing platform comprising one or more processing devices each having a processor coupled to a memory. Such processing devices can illustratively include particular arrangements of compute, storage and network resources.

The data centers 102, the federated anomaly detection platform 106 and the client device 107 or components thereof may be implemented on respective distinct processing platforms, although numerous other arrangements are possible. For example, in some embodiments at least portions of the federated anomaly detection platform 106 and one or more of the data centers and/or one or more of the client devices 107 are implemented on the same processing platform. A given one of the client devices 107 can therefore be implemented at least in part within at least one processing platform that implements at least a portion of the federated anomaly detection platform 106.

The term “processing platform” as used herein is intended to be broadly construed so as to encompass, by way of illustration and without limitation, multiple sets of processing devices and associated storage systems that are configured to communicate over one or more networks. For example, distributed implementations of the information processing system 100 are possible, in which the data centers 102 are geographically distributed (e.g., data center 102-1 is in a first geographic location while data center 102-N is in another geographic location that is potentially remote from the first geographic location). Numerous other distributed implementations are possible. The federated anomaly detection platform 106 can also be implemented in a distributed manner across multiple data centers.

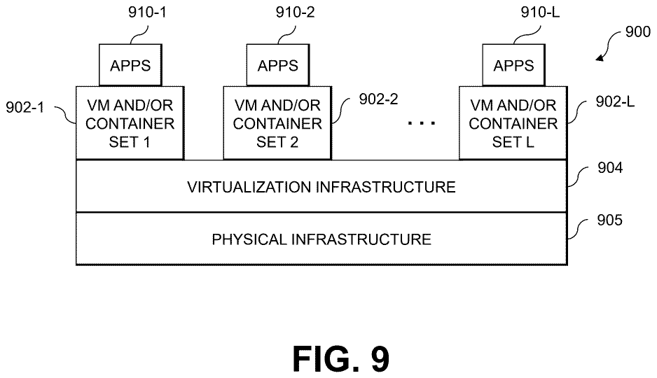

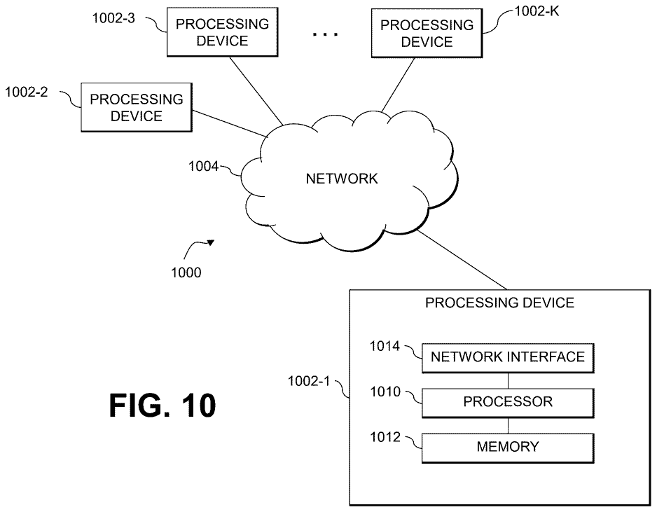

Additional examples of processing platforms utilized to implement the data centers 102, the federated anomaly detection platform 106 and other components of the information processing system 100 in illustrative embodiments will be described in more detail below in conjunction with FIGS. 9 and 10.

It is to be understood that the particular set of elements shown in FIG. 1 for federated machine learning-based anomaly detection across multiple data centers is presented by way of illustrative example only, and in other embodiments additional or alternative elements may be used. Thus, another embodiment may include additional or alternative systems, devices and other network entities, as well as different arrangements of modules and other components.

It is to be appreciated that these and other features of illustrative embodiments are presented by way of example only, and should not be construed as limiting in any way.

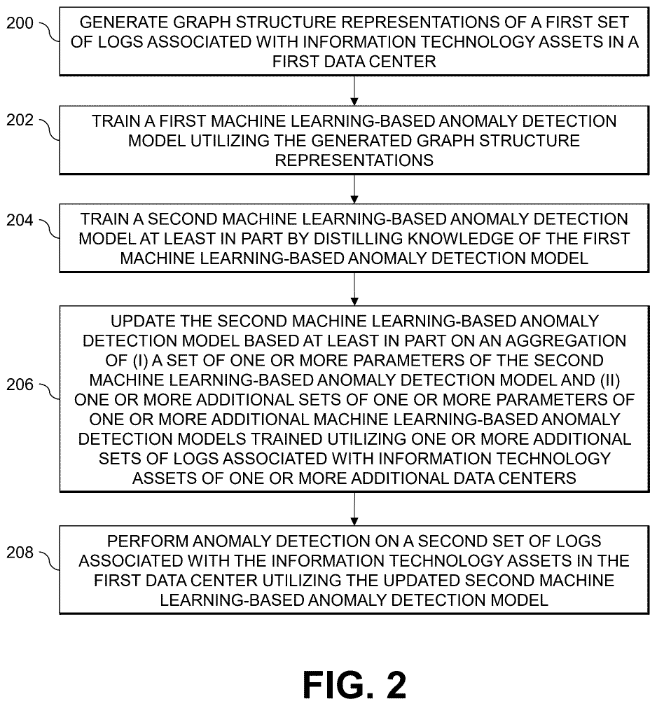

An exemplary process for federated machine learning-based anomaly detection across multiple data centers will now be described in more detail with reference to the flow diagram of FIG. 2. It is to be understood that this particular process is only an example, and that additional or alternative processes for federated machine learning-based anomaly detection across multiple data centers may be used in other embodiments.

In this embodiment, the process includes steps 200 through 208. These steps are assumed to be performed by the data centers 102 utilizing the local anomaly detection teacher model generation logic 124, the local anomaly detection student model distillation logic 126 and the local anomaly detection student model parameter distribution logic 128, and/or by the F-HGAR tool 160 utilizing the local anomaly detection student model parameter aggregation logic 162, the global anomaly detection student model generation logic 164, and the global anomaly detection student model parameter redistribution logic 166. The process begins with step 200, generating graph structure representations of a first set of logs associated with information technology assets in a first data center.

In step 202, a first machine learning-based anomaly detection model is trained utilizing the generated graph structure representations. The first machine learning-based anomaly detection model may comprise a Generative Adversarial Network (GAN)-based anomaly detection model. Step 202 may include performing local adversarial training on the graph structure representations generated from the first set of logs associated with the one or more information technology assets in the first data center to determine graph-level embeddings for the graph structure representations for each of two or more time slices. The local adversarial training may be based at least in part on a mutual information loss term computed as a function of (i) local mutual information characterizing consistency of node-level embeddings for nodes of the graphs structure representations and the determined graph-level embeddings for each of the two or more time slices and (ii) global mutual information separating the determined graph-level embeddings for anomalous and non-anomalous ones of the graph structure representations for each of the two or more time slices. Step 202 may further include performing temporal graph distillation to accumulate information across the two or more time slices characterizing how anomalies evolve or dissipate over multiple ones of the two or more time slices. The temporal graph distillation may utilize at least one of a Long Short Term Memory (LSTM) machine learning model and a Temporal Graph Convolutional Network (T-GCN) machine learning model. Performing temporal graph distillation may utilize a time-attention scalar characterizing contribution of each of the two or more time slices to a final anomaly score for respective ones of the graph structure representations.

The FIG. 2 process continues with step 204, training a second machine learning-based anomaly detection model at least in part by distilling knowledge of the first machine learning-based anomaly detection model. The first machine learning-based anomaly detection model may have a first complexity and the second machine learning-based anomaly detection model may have a second complexity, the second complexity being less than the first complexity. The first machine learning-based anomaly detection model may have a first size and the second machine learning-based anomaly detection model may have a second size, the second size being less than the first size. Step 204 may include training the second machine learning-based anomaly detection model to mimic outputs of the first machine learning-based anomaly detection model.

In step 206, the second machine learning-based anomaly detection model is updated based at least in part on an aggregation of (i) a set of one or more parameters of the second machine learning-based anomaly detection model and (ii) one or more additional sets of one or more parameters of one or more additional machine learning-based anomaly detection models trained utilizing one or more additional sets of logs associated with information technology assets of one or more additional data centers. Step 206 may include re-training the second machine learning-based anomaly detection model to identify one or more anomalies encountered in at least one of the one or more additional data centers which have not been encountered in the first data center. Step 206 may also or alternatively include re-training the second machine learning-based anomaly detection model to identify one or more distributed anomalies encountered across multiple ones of the first and one or more additional data centers. The aggregation may comprise a federated averaging of (i) the set of one or more parameters of the second machine learning-based anomaly detection model and (ii) the one or more additional sets of one or more parameters of the one or more additional machine learning-based anomaly detection models trained utilizing the one or more additional sets of logs associated with the information technology assets of the one or more additional data centers. The aggregation may preserve data privacy for (i) the set of one or more parameters of the second machine learning-based anomaly detection model and (ii) the one or more additional sets of one or more parameters of the one or more additional machine learning-based anomaly detection models trained utilizing the one or more additional sets of logs associated with the information technology assets of the one or more additional data centers.

In step 208, anomaly detection is performed on a second set of logs associated with the information technology assets in the first data center utilizing the updated second machine learning-based anomaly detection model.

The particular processing operations and other system functionality described in conjunction with the flow diagram of FIG. 2 are presented by way of illustrative example only, and should not be construed as limiting the scope of the disclosure in any way. Alternative embodiments can use other types of processing operations. For example, as indicated above, the ordering of the process steps may be varied in other embodiments, or certain steps may be performed at least in part concurrently with one another rather than serially. Also, one or more of the process steps may be repeated periodically, multiple instances of the process can be performed in parallel with one another, etc.

Functionality such as that described in conjunction with the flow diagram of FIG. 2 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

Federated anomaly detection and Graph Neural Networks (GNNs) may be used to address data privacy and computational constraints. GNNs may be utilized in anomaly detection tasks. A Federated Graph Anomaly Detection (FGAD) framework utilizes self-boosted knowledge distillation within federated graph learning, addressing heterogeneity in client models but failing to incorporate temporal dynamics. A Federated Anomaly Detection with Noisy Global Density Estimation, and Self-supervised Ensemble Distillation (FADngs) framework leverages graph clustering and ensemble distillation, but suffers from a high computational overhead due to clustering complexity. Knowledge distillation mechanisms focus on reducing model size while maintaining accuracy. For example, reconstructed GNNs use bidirectional distillation, but their models lack explicit temporal embeddings. In the IoT domain, temporal patterns may be incorporated using federated learning but primarily focus on time-series data rather than graph-based structures. Capturing fleeting anomalies in federated settings remains challenging. A Parameter-efficient Federated Anomaly Detection (PeFAD) framework explores temporal anomalies but relies on conventional time-series approaches, neglecting the integration of structural and temporal embeddings into a unified framework.

Illustrative embodiments provide technical solutions for federated anomaly detection which utilize an F-HGAR framework. In some embodiments, the F-HGAR framework is specifically tailored for distributed server log data across multiple data centers (e.g., global facilities of an enterprise). Advantageously, the F-HGAR framework is able to preserve data privacy by training locally at each data center and exchanging only model parameters with a central server.

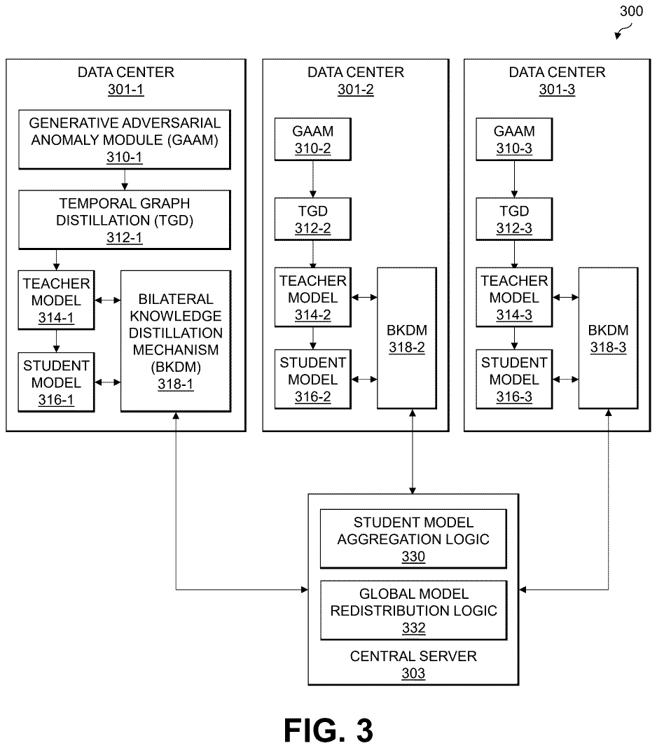

FIG. 3 shows an architecture 300 of an F-HGAR framework, which includes data centers 301-1, 301-2 and 301-3 (collectively, data centers 301) and a central server 303. The data centers 301-1, 301-2 and 301-3 implement respective instances of a Generative Adversarial Anomaly Module (GAAM) 310-1, 310-2 and 310-3 (collectively, GAAMs 310) as well as Temporal Graph Distillation (TGD) sub-modules 312-1, 312-2 and 312-2 (collectively, TGD sub-modules 312). The GAAMs 310 employ adversarial generation and local-global mutual information to distinguish normal from anomalous graphs at each of the data centers 301. The TGD sub-modules 312 are integrated within the GAAM's teacher model, and are configured to partition logs into time-sliced subgraphs to capture transient or short-lived anomalies. Within each of the data centers 301, the GAAMs 310 and TGD sub-modules 312 collaboratively train respective teacher models 314-1, 314-2 and 314-3 (collectively, teacher models 314), whose knowledge is distilled into respective lightweight student models 316-1, 316-2 and 316-3 (collectively, student models 316) utilizing respective instances of a Bilateral Knowledge Distillation Mechanism (BKDM) 318-1, 318-2 and 318-3 (collectively, BKDMs 318). The BKDMs 318 transfer the knowledge of the teacher models 314 (e.g., the GAAMs 310 and TGD sub-modules 312) to the lightweight student models 316 for efficient federated aggregation and global collaboration. The student models 316 are aggregated at central server 303 using student model aggregation logic 330 to form a global model which is redistributed to the data centers 301 utilizing global model redistribution logic 332.

The F-HGAR framework provides a privacy-preserving and federated learning process, which explicitly fuses structural and temporal cues through TGD. Further, the F-HGAR framework scales efficiently under privacy constraints, offering robustness in non-IID (independent and identically distributed) environments. The non-IID adaptation preserves local peculiarities via the teacher models 314 while sharing global insights through the lightweight student models 316. Thus, the F-HGAR framework is advantageously privacy-preserving and provides temporal awareness, structural-temporal fusion and lightweight knowledge sharing as well as non-IID adaptation.

The F-HGAR framework federates adversarial graph anomaly detection across the multiple data centers 301, while also incorporating temporal dynamics. The GAAMs 310 perform local adversarial training on graphs constructed from server logs, and integrate a Local-Global Mutual information component to separate normal and anomalous embeddings while enforcing node-to-graph consistency. The TGD sub-modules 312 are integrated with the GAAMs 310, and divide logs into time slices at each of the data centers 301. The TGD sub-modules 312 utilize a temporal network (e.g., an LSTM, a T-GCN model) to capture evolving anomalies, and merge structural embeddings from the GAAMs 310 with temporal embeddings before applying anomaly classification and mutual information objectives. Each of the data centers 301 provides and retains one of the teacher models 314 (e.g., combining its one of the GAAMs 310 and TGD sub-modules 312) locally, while utilizing BKDMs 318 to distill the student models 316 for lightweight sharing in a federated loop, reducing communication and preserving privacy. Altogether, the F-HGAR framework addresses non-IID distributions, ephemeral anomalies, and data governance requirements in large-scale, multi-center deployments.

Advantageously, the GAAMs 310 of the F-HGAR framework are augmented with dual mutual information objectives, enabling robust separation of normal and anomalous graphs in a distributed setting. By maximizing the node-to-graph mutual information (MI) while minimizing normal-anomaly MI, the GAAMs 310 excel at recognizing subtle yet critical anomalies under data privacy constraints. Further, to address non-IID data across the multiple data centers 301, the BKDMs 318 are developed to provide teacher-student distillation in heterogeneous environments, enabling each of the data centers 301 to locally train the comprehensive teacher models 314 and distill essential anomaly detection representations into lighter student models 316, which are then federated to share knowledge globally without revealing sensitive local data. The TGD sub-modules 312 address ephemeral anomalies, through providing functionality for slicing system logs into time intervals and employing a dual-stream teacher network, combining structural and temporal embeddings. The TGD sub-modules 312 implement an attention-based weighting scheme that highlights intervals most indicative of anomalies, increasing sensitivity to transient and short-lived events in real-world log data.

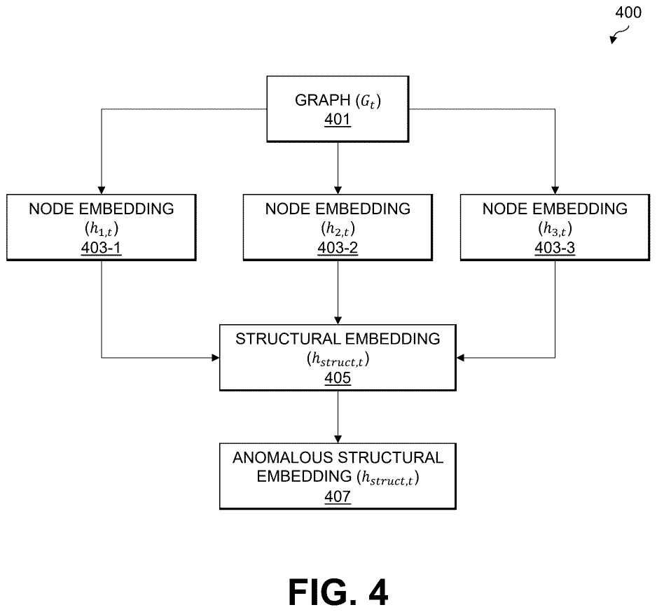

Each of the GAAMs 310 includes a synthesizer S which generates candidate anomalous graphs and a verifier V which classifies real versus synthetic (e.g., potentially anomalous) graphs. FIG. 4 shows a mutual information framework 400 provided by each of the GAAMs 310, which is configured to process a graph 401 (Gₜ) to generate node embeddings 403-1 (h_{1,t}), 403-2 (h_{2,t}) and 403-3 (h_{3,t}). The node embeddings 403-1, 403-2 and 403-3 are collectively referred to as node embeddings 403, which are aligned with structural embeddings 405 (h_{struct,t}) through local MI maximization while differentiating anomalous structural embeddings 407 from normal structural embeddings via global MI minimization. This approach effectively enhances anomaly detection by leveraging both local and global relationships.

Notation for a single time slice will now be described. To clarify how TGD integrates with GAAM, the GAAM for a single time slice t is denoted as follows. Gₜ=(Aₜ, Xₜ) denotes the graph derived from logs in the t-th time window. The verifier [symbol] outputs a structural embedding h_{struct,t} for time t after processing Gₜ. Local MI ensures node-level embeddings are consistent with the graph-level embedding within each time slice t. For node i in Gₜ, let h_{i,t} be its node embedding, and h_{struct,t} be the graph-level embedding. Local MI maximizes:

$${I}_{local} ( {G}_{t} ) ∝ {\sum }_{i ∈ {G}_{t}} log \frac{p ( {h}_{i , t} , {h}_{struct , t} )}{p ( {h}_{i , t} ) p ( {h}_{struct , t} )}$$

Global MI separates embeddings for normal and anomalous graphs. Suppose at time t, normal graphs have embeddings

$${h}_{struct , t}^{( norm )}$$

and anomalous graphs have embeddings

$${h}_{struct , t}^{( anom )} .$$

Global MI minimizes:

$${I}_{global} = {\sum }_{{G}_{t}^{( norm )} {G}_{t}^{( anom )}} log \frac{p ( {h}_{struct , t}^{( norm )} , {h}_{struct , t}^{( anom )} )}{p ( {h}_{struct , t}^{( norm )} ) p ( {h}_{struct , t}^{( anom )} )}$$

Combining these yields a mutual information loss term:

$${ℒ}_{MI , t} ( 𝒮 , 𝒱 ) = - {λ}_{local} {I}_{local} ( {G}_{t} ) + {λ}_{global} {λ}_{global}$$

Synthesizer [symbol] draws a latent vector zₜ at time t:

$${z}_{t} = μ + σ \cdot ϵ , ϵ \sim 𝒩 ( 0 , I )$$

The synthesizer [symbol] generates synthetic adjacency matrix Ãₜ and features \tilde{X}ₜ. Verifier V attempts to classify whether a graph (Aₜ, Xₜ) is real-normal or synthesized-anomalous. The adversarial loss is:

$${ℒ}_{adv , t} ( 𝒮 , 𝒱 ) = {𝔼}_{{G}_{t} \sim Data} [ log 𝒱 ( {G}_{t} ) ] + {𝔼}_{{\tilde{G}}_{t} \sim 𝒮} [ log ( 1 - 𝒱 ( {\tilde{G}}_{t} ) ) ]$$

The teacher model handles sequences of Gₜ across time slices t=1, 2, . . . , T, by summing or averaging losses [symbol] _{MI,t} and [symbol] _{adv,t} over all t.

TGD introduces a temporal dimension so that the teacher model captures how anomalies evolve or dissipate over time. Let T be the number of time slices. The teacher model architecture includes a structural stream and a temporal stream. The structural stream includes, for each t, the verifier [symbol] in the GAAM producing a structural embedding h_{struct,t} and deriving node embeddings {h_{i,t}} for local MI calculations. The temporal stream includes a temporal module (e.g., LSTM, T-GCN, etc.) that accumulates information across slices, e.g.:

$${h}_{temp , t} = LSTM ( {h}_{temp , t - 1} , {h}_{struct , t} )$$

or a specialized temporal graph network function:

$${h}_{temp , t} = T - GCN ( {G}_{t} , {h}_{temp , t - 1} )$$

The fusion and final teacher representation is:

$${h}_{teacher , t} = {W}_{f} [ {h}_{struct , t} ⊕ {h}_{tempt , t} ]$$

where ⊕ indicates concatenation or another fusion method, and We is a learnable parameter matrix. h_{teacher,t} is utilized within the adversarial classification step (e.g., the Verifier [symbol] 's final layer can base decisions on the fused embedding), as well as in the local-global MI terms by substituting h_{struct,t} with h_{teacher,t} whenever temporal cues are incorporated. Specifically, for local MI, each node's embedding h_{i,t} is aligned with h_{teacher,t} rather than h_{struct,t}. Similarly, for global MI, normal/anomalous graph embeddings compare

$${h}_{t e a c h e r , t}^{( norm )} versus {h}_{teacher , t}^{( anom )} .$$

In some embodiments, a time-attention scalar at is added to emphasize intervals with strong anomaly signals:

$${α}_{t} = \frac{exp ( {W}_{α}^{T} {h}_{teacher , t} )}{{\sum }_{τ = 1}^{T} exp ( {W}_{α}^{T} {h}_{teacher , τ} )}$$

with αₜ influencing how each time slice contributes to the final anomaly score or the local-global MI objective. In summary, TGD modifies GAAM's embeddings from h_{struct,t} to h_{teacher,t} (combining structural and temporal aspects) for enhanced detection of short-lived anomalies.

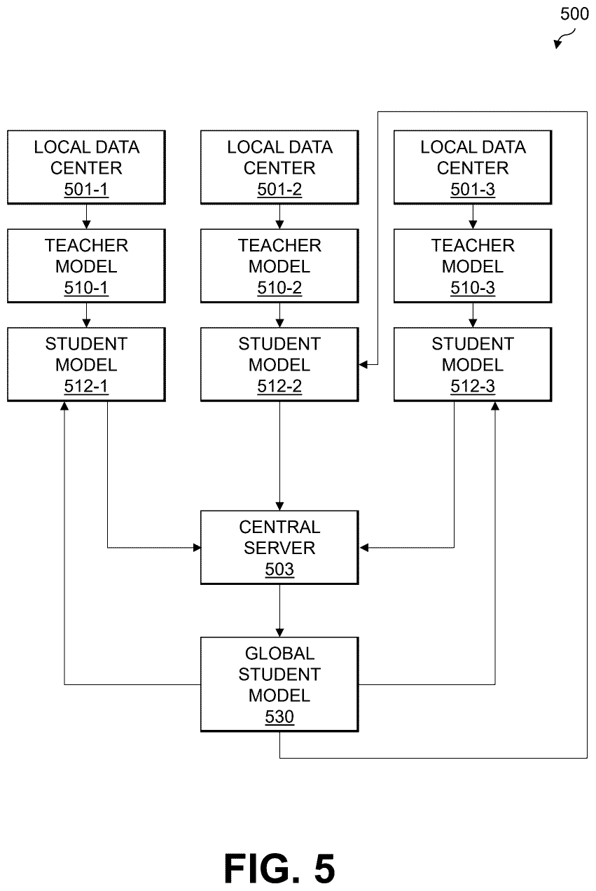

The BKDM enables federated training across data centers, as illustrated in system 500 of FIG. 5. The system 500 includes local data centers 501-1, 501-2 and 501-3 (collectively, data centers 501) and a central server 503. The data centers 501 generate respective teacher models 510-1, 510-2 and 510-3 (collectively, teacher models 510) and student models 512-1, 512-2 and 512-3 (collectively, student models 512). The local data centers 501 provide the student models 512 or portions thereof (e.g., model parameters) to the central server 503, which generates a global student model 530, and the central server 503 redistributes the global student model 530 or portions thereof (e.g., model parameters) back to the data centers 501. In the system 500, the BKDM balances local and global learning by transferring knowledge from the teacher models 510 to the student models 512 within the data centers 501, aggregating parameters at the central server 503, and redistributing the global student model 530 back to the data centers 501. The process enhances collaborative model training across distributed environments.

Local teacher training includes each data center training its teacher model (e.g., GAAM+TGD) on its own time-sliced graphs {G₁, . . . , G_{T}} and minimizing a combined loss:

$${ℒ}_{teacher} = {\sum }_{t = 1}^{T} [ {ℒ}_{adv , t} + {ℒ}_{MI , t} ] + ( regularization )$$

Teacher-student distillation includes training a student model (a lighter version of GAAM+TGD) to mimic the teacher's intermediate and final outputs:

$${ℒ}_{distill} = {\sum }_{t = 1}^{T} {‖ {f}_{student} ( {G}_{t} ) - {h}_{teacher , t} ‖}^{2}$$

where f_{student}(Gₜ) represents the student model's final representation at slice t. Optionally, node-level embeddings or logits can also be matched.

Federated aggregation includes each data center sending only the student model parameters

$$( {θ}_{student}^{( k )} )$$

to the central server. The central server aggregates the student model parameters from the local data centers (e.g., using a Federated Averaging algorithm, denoted FedAvg):

$${θ}_{student} ← \frac{1}{N} {\sum }_{k = 1}^{N} {θ}_{student}^{( k )}$$

This produces a “global” student model that captures broad anomaly patterns from all sites (e.g., all the local data centers). The global student model is disseminated back to each local data center. Each of the local data centers refines the global student model further via local distillation from its teacher model. Over multiple communication rounds, newly discovered anomalies in any data center propagate to others. Thus, BKDM ensures minimal bandwidth usage (e.g., the generator portion of GAAM need not be transmitted) while allowing each site to preserve its unique teacher model, aligning local-global knowledge for robust anomaly detection in non-IID environments.

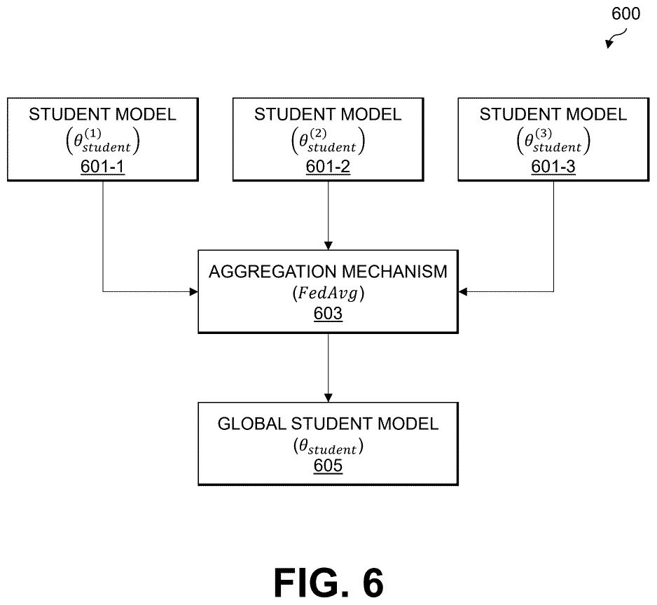

FIG. 6 shows a federated parameter aggregation process 600, where student model parameters

$$601 - 1 ( {θ}_{student}^{( 1 )} ) , 601 - 2 ( {θ}_{student}^{( 2 )} ) and 601 - 3 ( {θ}_{student}^{( 3 )} )$$

from distributed data centers (collectively, student model parameters 601) are consolidated utilizing aggregation mechanism 603 (e.g., FedAvg) producing a unified global student model 605 (θ_{student}). This approach ensures collaborative learning while preserving data privacy.

An enterprise may operate a global network of data centers that provides its customers or other users with essential services such as cloud computing, storage and networking. These data centers host large-scale server clusters, which generate vast amounts of system logs, network traffic logs and alert information daily. These logs are critical for monitoring the health, performance and security of the infrastructure. However, due to compliance and security regulations, certain countries or regions enforce strict data privacy laws that prohibit the aggregation of raw logs for centralized analysis. This creates a significant challenge for anomaly detection, where centralized methods often rely on access to complete datasets to identify patterns and detect irregularities. As a result, the enterprise must explore distributed approaches to analyze logs to comply with these privacy constraints.

Anomalous behaviors in server logs often indicate critical issues such as cyberattacks, hardware failures or performance degradation. However, these anomalies are typically localized, appearing only in specific features or within very short time windows. This makes them difficult to detect without advanced, context-aware methods. Additionally, the log formats and distributions vary significantly across an enterprise's data centers due to differences in hardware, software and operational environments. This non-IID nature of the data further complicates the deployment of traditional centralized or single-site anomaly detection methods, as these approaches are often unsuitable for handling such heterogeneity. Further, relying solely on independent anomaly detection at each data center limits the ability to identify large-scale attacks or distributed failure patterns that span multiple locations. This lack of a collaborative framework hinders timely detection and response to system threats.

To address these and other technical challenges, the F-HGAR framework is applied to effectively handle distributed log analysis. F-HGAR leverages graph structures to represent the relationships between servers and log events within each data center. In this representation, nodes correspond to entities such as servers, VMs, or key log events, while edges capture relationships such as server-to-server communications, dependencies, or event co-occurrences, including temporal dependencies between anomaly alerts. The F-HGAR framework employs a mutual information optimization strategy to accurately distinguish between normal and anomalous patterns in server and log graphs. Teacher models are deployed locally at each data center to perform graph representation learning and anomaly detection on their respective log data. These teacher models extract the unique characteristics of local environments and detect anomalies within the data center. To enable collaboration across data centers, student models are trained using knowledge distilled from the teacher models. These student models participate in a federated learning framework, where their parameters are aggregated at a central server. This process allows the student models to absorb statistical patterns from multiple data centers while preserving data privacy. The dual knowledge distillation mechanism ensures that the student models retain the unique characteristics of their local environments while continuously evolving to learn more generalized anomaly patterns at a global level. This approach improves the framework's adaptability to the non-IID nature of the data across data centers.

The F-HGAR application flow includes:
1. Local Graph Construction: each data center creates time-sliced graphs {G₁, . . . , G_{T}} from their logs.
2. Teacher Training: the teacher model (GAAM+TGD) learns to detect anomalies both structurally and temporally, yielding h_{teacher,t} for each slice.
3. Student Distillation: the teacher model's knowledge is transferred to a local student model, reducing model complexity.
4. Federated Parameter Aggregation: student models are periodically aggregated on a central server, promoting cross-data center synergy.
5. Redistribution: the updated global student model is broadcast back to the data centers, improving detection at each site such that emerging anomalies at one data center become known to others speeding up overall threat response.

In some embodiments, the F-HGAR framework may incorporate differential privacy techniques. In scenarios with higher privacy requirements, methods like Differentially Private Stochastic Gradient Descent (DP-SGD) can be added to ensure privacy protection during parameter transmission. Further, the F-HGAR framework may be integrated with automated operations (AIOps) systems, where federated anomaly detection results can be integrated with automated operations solutions to enable real-time alerts as well as isolation and repair of suspicious nodes or business processes.

Experimental results utilizing the F-HGAR framework will now be described, with respect to the use of an open-source dataset, illustrating how the F-HGAR framework behaves in performing federated anomaly detection on graph-structured data demonstrating the feasibility and advantages of the F-HGAR framework. The open-source dataset used includes connection-level records for intrusion detection, following common practices to transform samples from selected time windows into graphs where nodes represent Internet Protocol (IP) addresses or host identifiers derived from the logs, edges represent interaction events (e.g., Transport Control Protocol (TCP) connections) occurring within each time slice, and features include encoded network properties (e.g., duration, protocol, etc.). In a federated setting, N=3 virtual data centers are simulated, each receiving a non-IID subset of the open-source dataset (e.g., subsets with varying attack types and frequencies). This simplified setup mirrors the real-life distribution of system logs across multiple facilities or other data centers.

The F-HGAR framework implements GAAM as a graph-based generator or synthesizer [symbol] and a verifier [symbol] , where the generator or synthesizer S produces synthetic anomalous subgraphs, while the verifier [symbol] (e.g., a GNN-based discriminator) classifies real versus synthetic inputs. The F-HGAR framework also implements TGD, integrating an LSTM-based temporal stream which fuses historical graph embeddings with structural embeddings to capture fleeting anomalies. The F-HGAR framework further utilizes BKDM where each data center trains a teacher model (e.g., GAAM+TGD) and distills the teacher model into a lighter student model, and then exchanges only the student model parameters (e.g., using FedAvg) with a central server. In some embodiments, the F-HGAR framework is implemented using PyTorch, applying early stopping on local teacher models to prevent overfitting. In the experiment, no aggressive hyperparameter tuning was performed, emphasizing that the results serve as an illustrative baseline.

To evaluate performance of the F-HGAR framework, various evaluation metrics are used for measuring anomaly detection performance, including: accuracy (Acc) indicating a fraction of correctly classified samples (e.g., normal versus anomalous), where a higher value is better; precision (Pre) indicating, out of all predicted anomalies, the proportion that are truly anomalous, where a higher value is better; recall (Rec) indicating, out of all true anomalies, the proportion that are successfully detected, where a higher value is better; F1-Score (F1) indicating the harmonic mean of precision and recall, balancing false positives and negatives; and AUC (Area under the Receiver Operating Characteristic (ROC) Curve) reflecting the trade-off between true positives and false positives, where a higher value is better. Performance of the F-HGAR framework is compared against several baseline methods, including: Local-Only GNN where each data center trains its own GNN-based anomaly detector without sharing any knowledge; Vanilla T-GCN where a T-GCN is used for anomaly detection without a federated or adversarial component; and FGAD where a self-boosted knowledge distillation method is used for federated graph anomaly detection which lacks explicit temporal embedding.

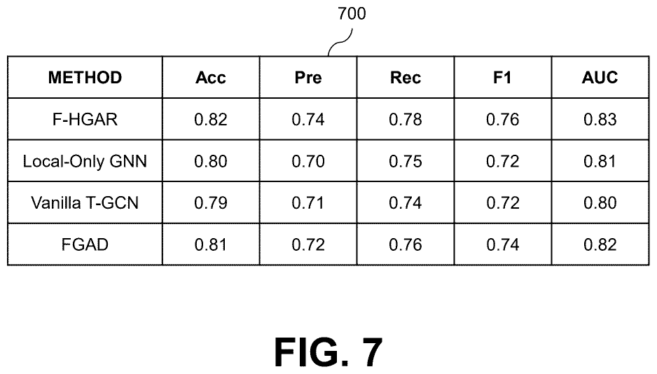

FIG. 7 shows a table 700 illustrating values of the above-described evaluation metrics for the F-HGAR framework and the baseline methods with the experimental dataset, illustrating how the F-HGAR framework consistently outperforms the baselines by noticeable margins on all metrics. Notably, the F-HGAR framework achieves a higher recall, suggesting it more effectively captures short-lived anomalies that the baseline methods often overlook.

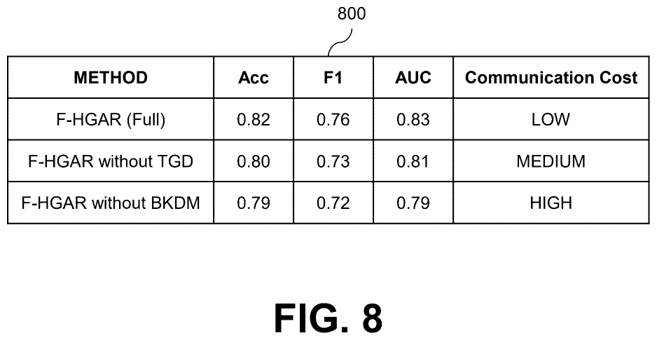

Each module or component of the F-HGAR framework is further evaluated via an ablation study comparing: the full F-HGAR framework (the complete framework, including GAAM, TGD and BKDM); F-HGAR without TGD (removing the temporal LSTM stream and relying solely on GAAM for spatial structure); and F-HGAR without BKDM (removing the bilateral distillation and performing naïve parameter averaging across local teachers). FIG. 8 shows a table 800 illustrating the values for the Acc, F1 and AUC evaluation metrics and also considering communication overhead (Comm. Cost) for the F-HGAR ablation study. This illustrates that both TGD and BKDM contribute positively to the final performance, highlighting their importance in capturing short-term anomalies and reducing communication overhead while preserving local data privacy. Omitting TGD diminishes the model's ability to capture temporal patterns, thus reducing anomaly recall. Removing BKDM increases communication overhead (e.g., due to larger teacher models being shared) and slightly reduces detection performance, indicating that local-global knowledge synchronization is advantageous.

While the experiment is performed on a simplified open-source dataset, the key components of the F-HGAR framework (e.g., GAAM, TGD and BKDM) are directly transferable to real-world multi-data center operating scenarios, where the federated adversarial module (e.g., a GAAM) handles distributed server log graphs without moving raw data, temporal distillation (e.g., TGD) captures short-term issues (e.g., CPU spikes, network anomalies, etc.), and bilateral distillation (e.g., BKDM) ensures efficient global learning with minimal bandwidth usage, which is beneficial when orchestrating many worldwide facilities or other data centers. Further, by incorporating enterprise-specific data sources (e.g., local site logs, firmware updates, IoT logs, etc.), the F-HGAR framework is expected to deliver real-time, privacy-preserving threat detection.

The technical solutions described herein provide the F-HGAR framework for cross-data center federated anomaly detection, including integrating TGD with GAAM to form a teacher model that captures both structural and temporal cues. By distilling these rich representations into a lighter student model, BKDM facilitates robust, privacy-preserving collaboration across heterogenous sites. The technical solutions thus provide a powerful approach for detecting short-lived anomalies, respecting regional data laws, and scaling effectively to real-world, global data center environments.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for federated machine learning-based anomaly detection across multiple data centers will now be described in greater detail with reference to FIGS. 9 and 10. Although described in the context of system 100, these platforms may also be used to implement at least portions of other information processing systems in other embodiments.

FIG. 9 shows an example processing platform comprising cloud infrastructure 900. The cloud infrastructure 900 comprises a combination of physical and virtual processing resources that may be utilized to implement at least a portion of the information processing system 100 in FIG. 1. The cloud infrastructure 900 comprises multiple virtual machines (VMs) and/or container sets 902-1, 902-2, . . . 902-L implemented using virtualization infrastructure 904. The virtualization infrastructure 904 runs on physical infrastructure 905, and illustratively comprises one or more hypervisors and/or operating system level virtualization infrastructure. The operating system level virtualization infrastructure illustratively comprises kernel control groups of a Linux operating system or other type of operating system.

The cloud infrastructure 900 further comprises sets of applications 910-1, 910-2, . . . 910-L running on respective ones of the VMs/container sets 902-1, 902-2, . . . 902-L under the control of the virtualization infrastructure 904. The VMs/container sets 902 may comprise respective VMs, respective sets of one or more containers, or respective sets of one or more containers running in VMs.

In some implementations of the FIG. 9 embodiment, the VMs/container sets 902 comprise respective VMs implemented using virtualization infrastructure 904 that comprises at least one hypervisor. A hypervisor platform may be used to implement a hypervisor within the virtualization infrastructure 904, where the hypervisor platform has an associated virtual infrastructure management system. The underlying physical machines may comprise one or more distributed processing platforms that include one or more storage systems.

In other implementations of the FIG. 9 embodiment, the VMs/container sets 902 comprise respective containers implemented using virtualization infrastructure 904 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 900 shown in FIG. 9 may represent at least a portion of one processing platform. Another example of such a processing platform is processing platform 1000 shown in FIG. 10.

The processing platform 1000 in this embodiment comprises a portion of system 100 and includes a plurality of processing devices, denoted 1002-1, 1002-2, 1002-3, . . . 1002-K, which communicate with one another over a network 1004.

The network 1004 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 1002-1 in the processing platform 1000 comprises a processor 1010 coupled to a memory 1012.

The processor 1010 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU), a neural processing unit (NPU), a data processing unit (DPU), a System-On-Chip (SOC) or other type of processing circuitry, as well as portions or combinations of such circuitry elements.

The memory 1012 may comprise random access memory (RAM), read-only memory (ROM), flash memory or other types of memory, in any combination. The memory 1012 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1002-1 is network interface circuitry 1014, which is used to interface the processing device with the network 1004 and other system components, and may comprise conventional transceivers.

The other processing devices 1002 of the processing platform 1000 are assumed to be configured in a manner similar to that shown for processing device 1002-1 in the figure.

Again, the particular processing platform 1000 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for federated machine learning-based anomaly detection across multiple data centers as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, IT assets, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured:
to generate graph structure representations of a first set of logs associated with information technology assets in a first data center;
to train a first machine learning-based anomaly detection model utilizing the generated graph structure representations;
to train a second machine learning-based anomaly detection model at least in part by distilling knowledge of the first machine learning-based anomaly detection model;
to update the second machine learning-based anomaly detection model based at least in part on an aggregation of (i) a set of one or more parameters of the second machine learning-based anomaly detection model and (ii) one or more additional sets of one or more parameters of one or more additional machine learning-based anomaly detection models trained utilizing one or more additional sets of logs associated with information technology assets of one or more additional data centers; and
to perform anomaly detection on a second set of logs associated with the information technology assets in the first data center utilizing the updated second machine learning-based anomaly detection model.

2. The apparatus of claim 1 wherein the first machine learning-based anomaly detection model comprises a Generative Adversarial Network (GAN)-based anomaly detection model.

3. The apparatus of claim 1 wherein training the first machine learning-based anomaly detection model comprises performing local adversarial training on the graph structure representations generated from the first set of logs associated with the one or more information technology assets in the first data center to determine graph-level embeddings for the graph structure representations for each of two or more time slices.

4. The apparatus of claim 3 wherein the local adversarial training is based at least in part on a mutual information loss term computed as a function of (i) local mutual information characterizing consistency of node-level embeddings for nodes of the graphs structure representations and the determined graph-level embeddings for each of the two or more time slices and (ii) global mutual information separating the determined graph-level embeddings for anomalous and non-anomalous ones of the graph structure representations for each of the two or more time slices.

5. The apparatus of claim 3 wherein training the first machine learning-based anomaly detection model further comprises performing temporal graph distillation to accumulate information across the two or more time slices characterizing how anomalies evolve or dissipate over multiple ones of the two or more time slices.

6. The apparatus of claim 5 wherein the temporal graph distillation utilizes at least one of a Long Short Term Memory (LSTM) machine learning model and a Temporal Graph Convolutional Network (T-GCN) machine learning model.

7. The apparatus of claim 5 wherein performing temporal graph distillation utilizes a time-attention scalar characterizing contribution of each of the two or more time slices to a final anomaly score for each of the graph structure representations.

8. The apparatus of claim 1 wherein the first machine learning-based anomaly detection model has a first complexity and the second machine learning-based anomaly detection model has a second complexity, the second complexity being less than the first complexity.

9. The apparatus of claim 1 wherein the first machine learning-based anomaly detection model has a first size and the second machine learning-based anomaly detection model has a second size, the second size being less than the first size.

10. The apparatus of claim 1 wherein training the second machine learning-based anomaly detection model comprises training the second machine learning-based anomaly detection model to mimic outputs of the first machine learning-based anomaly detection model.

11. The apparatus of claim 1 wherein updating the second machine learning-based anomaly detection model comprises re-training the second machine learning-based anomaly detection model to identify one or more anomalies encountered in at least one of the one or more additional data centers which have not been encountered in the first data center.

12. The apparatus of claim 1 wherein updating the second machine learning-based anomaly detection model comprises re-training the second machine learning-based anomaly detection model to identify one or more distributed anomalies encountered across multiple ones of the first and one or more additional data centers.

13. The apparatus of claim 1 wherein the aggregation comprises performing federated averaging of (i) the set of one or more parameters of the second machine learning-based anomaly detection model and (ii) the one or more additional sets of one or more parameters of the one or more additional machine learning-based anomaly detection models trained utilizing the one or more additional sets of logs associated with the information technology assets of the one or more additional data centers.

14. The apparatus of claim 1 wherein the aggregation preserves data privacy for (i) the set of one or more parameters of the second machine learning-based anomaly detection model and (ii) the one or more additional sets of one or more parameters of the one or more additional machine learning-based anomaly detection models trained utilizing the one or more additional sets of logs associated with the information technology assets of the one or more additional data centers.

15. A computer program product comprising a non-transitory processor-readable storage medium having stored therein program code of one or more software programs, wherein the program code when executed by at least one processing device causes the at least one processing device:
to generate graph structure representations of a first set of logs associated with information technology assets in a first data center;
to train a first machine learning-based anomaly detection model utilizing the generated graph structure representations;
to train a second machine learning-based anomaly detection model at least in part by distilling knowledge of the first machine learning-based anomaly detection model;
to update the second machine learning-based anomaly detection model based at least in part on an aggregation of (i) a set of one or more parameters of the second machine learning-based anomaly detection model and (ii) one or more additional sets of one or more parameters of one or more additional machine learning-based anomaly detection models trained utilizing one or more additional sets of logs associated with information technology assets of one or more additional data centers; and
to perform anomaly detection on a second set of logs associated with the information technology assets in the first data center utilizing the updated second machine learning-based anomaly detection model.

16. The computer program product of claim 15 wherein training the first machine learning-based anomaly detection model comprises performing local adversarial training on the graph structure representations generated from the first set of logs associated with the one or more information technology assets in the first data center to determine graph-level embeddings for the graph structure representations for each of two or more time slices.

17. The computer program product of claim 16 wherein training the first machine learning-based anomaly detection model further comprises performing temporal graph distillation to accumulate information across the two or more time slices characterizing how anomalies evolve or dissipate over multiple ones of the two or more time slices.

18. A method comprising:
generating graph structure representations of a first set of logs associated with information technology assets in a first data center;
training a first machine learning-based anomaly detection model utilizing the generated graph structure representations;
training a second machine learning-based anomaly detection model at least in part by distilling knowledge of the first machine learning-based anomaly detection model;
updating the second machine learning-based anomaly detection model based at least in part on an aggregation of (i) a set of one or more parameters of the second machine learning-based anomaly detection model and (ii) one or more additional sets of one or more parameters of one or more additional machine learning-based anomaly detection models trained utilizing one or more additional sets of logs associated with information technology assets of one or more additional data centers; and
performing anomaly detection on a second set of logs associated with the information technology assets in the first data center utilizing the updated second machine learning-based anomaly detection model;
wherein the method is performed by at least one processing device comprising a processor coupled to a memory.

19. The method of claim 18 wherein training the first machine learning-based anomaly detection model comprises performing local adversarial training on the graph structure representations generated from the first set of logs associated with the one or more information technology assets in the first data center to determine graph-level embeddings for the graph structure representations for each of two or more time slices.

20. The method of claim 19 wherein training the first machine learning-based anomaly detection model further comprises performing temporal graph distillation to accumulate information across the two or more time slices characterizing how anomalies evolve or dissipate over multiple ones of the two or more time slices.
